(19) United States
(12) Patent Application Publication
(10) Pub. No.: US 2025/0218218 A1
(43) Pub. Date: Jul. 3, 2025

(54) BLINK DETECTION METHOD AND DEVICE AND COMPUTER-READABLE STORAGE MEDIUM

(71) Applicant: UBTECH ROBOTICS CORP LTD, Shenzhen (CN)

(72) Inventor: YUSHENG ZENG, Shenzhen (CN)

(21) Appl. No.: 18/977,959

(22) Filed: Dec. 12, 2024

(30) Foreign Application Priority Data
Dec. 28, 2023 (CN) 202311841212.8

(51) Int. Cl. G06V 40/18; G06V 10/44; G06V 10/77; G06V 10/776; G06V 40/16; G06V 40/20

(52) U.S. Cl. CPC G06V 40/193; G06V 10/457; G06V 10/7715; G06V 10/776; G06V 40/171; G06V 40/20

(57) ABSTRACT

A blink detection method includes: obtaining a number of first keypoints of at least one eye in a first image and a number of second keypoints of the at least one eye in a second image, wherein the first image is a previous image frame prior to the second image; adjusting the second keypoints based on a position offset between the first keypoints and the second keypoints, to obtain a number of adjusted second keypoints; and detecting a blink based on the first keypoints and the adjusted second keypoints.

### CROSS REFERENCE TO RELATED APPLICATIONS

This application claims priority to Chinese Patent Application No. CN 202311841212.8, filed Dec. 28, 2023, which is hereby incorporated by reference herein as if set forth in its entirety.

### TECHNICAL FIELD

The present disclosure generally relates to image processing technologies, and in particular relates to a blink detection method and device and computer-readable storage medium.

### BACKGROUND

Cognitive impairment is a disease caused by brain degeneration. The symptoms develop slowly and are not obvious at first, so they are easily ignored by family members. But as the disease progresses, it can profoundly affect both patients and caregivers. Early diagnosis allows patients to get the most benefit from available treatments and slow degeneration. Eye-tracking analysis is a common means of analyzing cognitive impairment. For example, low-frequency blinking generally means high concentration, while high-frequency blinking means distracted attention.

In some conventional approaches, the blinking state of the eyes can be detected based on face images. How to accurately detect the keypoints of the eyes from the face images is the core issue of blink detection.

Therefore, there is a need to provide a blink detection method to overcome the above-mentioned problems.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a device for detecting blink according to one embodiment.

FIG. 2 is an exemplary flowchart a blink detection method according to one embodiment.

FIG. 3 is a schematic block diagram of a detection model according to one embodiment

FIG. 4 is an example of the structure of the detection model.

FIG. 5 is a schematic block diagram for executing a training method according to one embodiment.

FIG. 6 is a schematic block diagram for executing a training method according to another embodiment.

FIG. 7 is a schematic block diagram for executing a training method according to yet another embodiment.

FIG. 8 is a schematic diagram of the keypoints of one eye according to one embodiment.

FIG. 9 is an exemplary flowchart of a blink detection method according to another embodiment.

FIG. 10 is an exemplary block diagram of a blink detection device according to another embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

Cognitive impairment is a disease caused by brain degeneration. The symptoms develop slowly and are not obvious at first, so they are easily ignored by family members. But as the disease progresses, it can profoundly affect both patients and caregivers. Early diagnosis allows patients to get the most benefit from available treatments and slow degeneration. Eye-tracking analysis is a common means of analyzing cognitive impairment. For example, low-frequency blinking generally means high concentration, while high-frequency blinking means distracted attention.

In some conventional approaches, the blinking state of the eyes can be detected based on face images. How to accurately detect the keypoints of the eyes from the face images is the core issue of blink detection

To address the above problem, the present disclosure provides a blink detection method. Specifically, according to the position offset between the keypoints of the human eyes in two consecutive image frames, the positions of the keypoints of the human eyes in the current image frame is adjusted, so as to obtain a more accurate positions of the keypoints of the human eye, thereby improving the reliability of blink detection.

As an example, but not a limitation, the method can be implemented by a device 10. The device 10 can be a desktop computer, laptop, handheld device, cloud server, or other computing device.

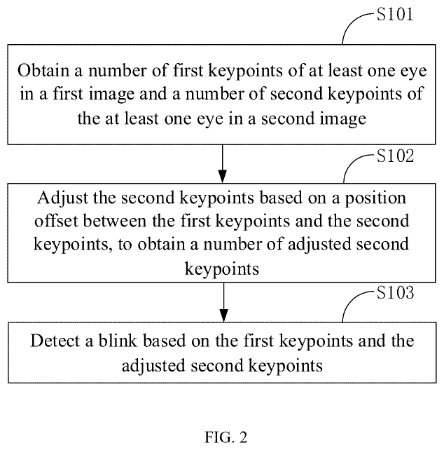

In one embodiment, the device 10 may include a processor 101, a storage 102, and one or more executable computer programs 103 that are stored in the storage 102. The storage 102 and the processor 101 are directly or indirectly electrically connected to one another to realize data transmission or interaction. For example, they can be electrically connected to one another through one or more communication buses or signal lines. The processor 101 performs corresponding operations by executing the executable computer programs 103 stored in the storage 102. When the processor 101 executes the computer programs 103, the steps in the embodiments of the image generation method, such as steps S101 to S103 in FIG. 2 are implemented.

The processor 101 may be an integrated circuit chip with signal processing capability. The processor 101 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the device 10, such as a hard disk or a memory. The storage 102 may also be an external storage device of the device 10, such as a plug-in hard disk, a smart memory card (SMC), and a secure digital (SD) card, or any suitable flash cards. Furthermore, the storage 102 may also include both an internal storage unit and an external storage device. The storage 102 is to store computer programs, other programs, and data required by the device 10. The storage 102 can also be used to temporarily store data that have been output or is about to be output.

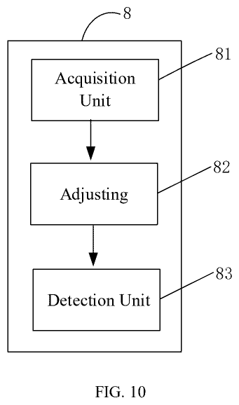

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the device 10. For example, the one or more computer programs 103 may be divided into an acquisition unit 81, an adjusting unit 82 and a detection unit 83 as shown in FIG. 10.

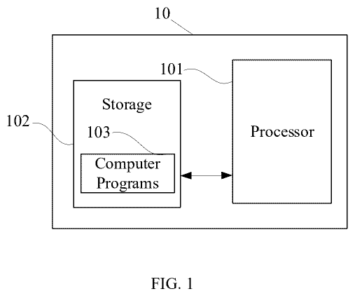

It should be noted that the block diagram shown in FIG. 1 is only an example of the device 10. The device 10 may include more or fewer components than what is shown in FIG. 1, or have a different configuration than what is shown in FIG. 1. Each component shown in FIG. 1 may be implemented in hardware, software, or a combination thereof.

FIG. 2 is a flowchart of a blink detection method according to one embodiment. As an example, but not a limitation, the method may include the following steps.

Step S101: Obtain a number of first keypoints of at least one eye in a first image and a number of second keypoints of the at least one eye in a second image, wherein the first image is a previous image frame prior to the second image.

In one embodiment, the keypoints of the at least one human eye in an image can be manually marked, but this approach is time-consuming and inefficient.

In one embodiment, step S101 may include the following steps: performing model training on a preset detection model to obtain a trained detection model; and inputting the first image into the trained detection model and outputting the first keypoints.

Using the trained detection model to detect the keypoints of the human eyes in an image can not only ensure the detection accuracy, but also help improve the detection efficiency.

In one embodiment, the detection model may include a first module for extracting first feature information based on an input image and a second module for extracting second feature information based on the first feature information. The dimension of the first feature information is greater than a dimension of the second feature information.

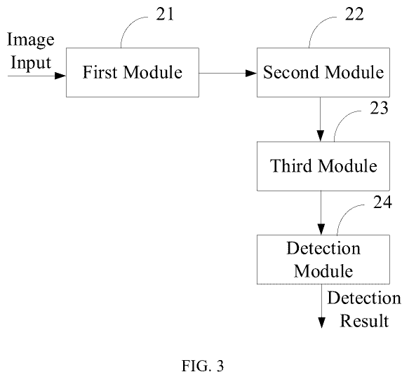

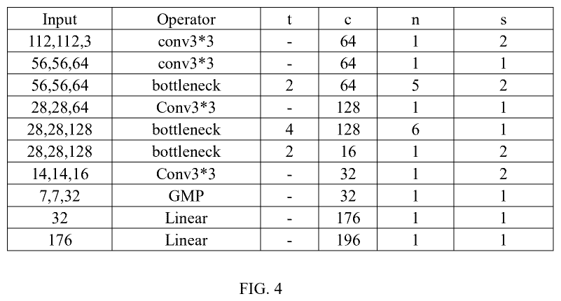

FIG. 3 is a schematic block diagram of a detection model according to one embodiment. As an example, but not a limitation, as shown in FIG. 3, the detection model may include a first module 21, a second module 22, a third module 23 and a detection module 24. During the image detection process, an image is input into the detection model. The first module 21 first performs shallow feature extraction on the input image to obtain the first feature information. The second module 22 then performs middle-level feature extraction on the first feature information to obtain the second feature information. The third module 23 then performs deep feature extraction on the second feature information to obtain the third feature information. Finally, the detection module 24 detects the keypoints of the human eyes in the input image according to the third feature information, and outputs the detection result. An example of the structure of the detection model is shown in FIG. 4, where t represents the transposed amplification factor in the bottleneck, c represents the number of convolution kernel channels, n represents the number of times the module (operator) is repeated, and s represents the convolution step stride.

As shown in FIG. 4, the size of the input image is (112, 112, 3). The first operator (i.e., conv3*3) is the first module 21, the number of convolution kernel channels is 64, the number of repetitions is 1, and the convolution step is 2. The second operator (conv3*3 with c=64, n=1, and s=1) and the third operator (bottleneck with t=2, c=64, n=5, and s=2) constitute the second module 22. The fourth operator (conv3*3 with c=128, n=1, and s=1), the fifth operator (bottleneck with t=4, c=128, n=6, and s=1) and the sixth operator (bottleneck with t=2, c=16, n=1, and s=2) constitute the third module 23. The seventh operator (conv3*3 with c=32, n=1, s=2), the eighth operator (GMP with c=32, n=1, s=1), the ninth operator (Linear with c=176, n=1, s=1) and the tenth operator (Linear with c=196, n=1, s=1) constitute the detection module 24. Here, GMP is to perform global pooling on the input data. Linear is to perform full connection on the input data. It should be noted that the above is only an example of a detection model, and the present disclosure does not specifically limit the structure, scale, etc. of the detection model.

In one embodiment, the steps for training a detection model may include: obtaining a sample image, wherein the sample image includes a face contour connected according to a number of marked facial keypoints; inputting the sample image into the detection model to obtain the first feature information output by the first module; calculating a feature average value according to the first feature information to obtain a mean feature map; calculating a first loss value according to the mean feature map and the face contour of the sample image; and updating the detection model according to the first loss value to obtain a trained detection model.

In one embodiment, the face contour can be formed by connecting the marked facial keypoints into a contour using a Bezier curve. In one embodiment, the mean feature map can be calculated by calculating the average value of the first feature information in the dimension of the image channel to obtain the mean feature map.

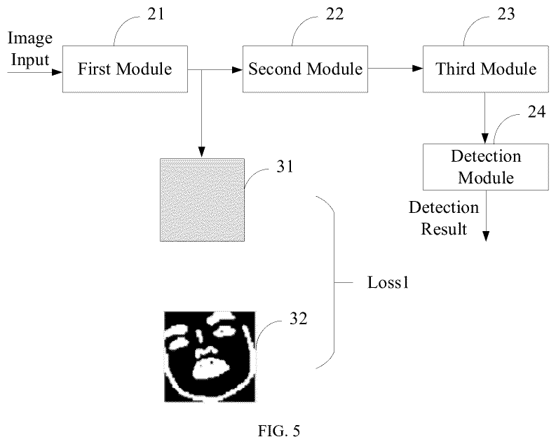

FIG. 5 is a schematic block diagram for executing a training method according to one embodiment. As shown in FIG. 5, a mean feature map 31 is generated according to the first feature information, and then a first loss value Loss1 is calculated according to the mean feature map 31 and the face contour 32.

For example, Loss1 can be calculated according to the following equation: Loss1=L1_smooth(fea_{contour}, contour_gt), where fea_{contour} represents the feature information of the mean feature map, contour_gt represents the feature information of the face contour, and indicates that the loss function adopts the L1_smooth function. It should be noted that, other loss functions, such as L1 function, L2 function, etc., can be used, and the present disclosure does not specifically limit this.

In the above-mentioned embodiment, it is equivalent to calculating the mean of the features of the shallow feature information. Through training, the mean feature map of the shallow feature information is made consistent with the face contour map of the sample image, so that the shallow features of the detection model learn the information related to the face contour, thereby improving the accuracy of key point detection.

In one embodiment, the steps for training a detection model may include: inputting the first feature information into the second module to obtain the second feature information, after the sample image is input into the detection model to obtain the first feature information output by the first module; inputting the first feature information and the second feature information into the third module to obtain third feature information; inputting the third feature information into the detection module to obtain a training result; calculating a second loss value based on the training result and the sample image; and updating the detection model based on the second loss value to obtain the trained detection model.

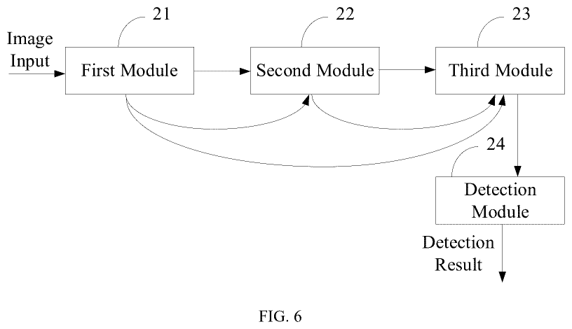

FIG. 6 is a schematic block diagram for executing a training method according to one embodiment. As shown in FIG. 6, the output of the first module 21 is not only connected to the second module 22, but also connected to the third module 23.

In one embodiment, the second loss value Loss2 may be calculated according to the following equation: Loss2=L1_smooth(keyᵣₑₛᵤₗₜ, key_gt), where feaᵣₑₛᵤₗₜ represents the keypoints in the training result, and key_gt represents the keypoints of the sample image.

As the network deepens, the semantics of feature extraction becomes more advanced, but some helpful low-level features (e.g., face contours, etc.) tend to be overlooked. In the above-mentioned embodiment, it is equivalent to multi-scale feature fusion of shallow features and high-level features, so that the detection model can learn the features of keypoints more comprehensively, thereby helping to improve the detection accuracy of the model.

In one embodiment, the steps for training a detection model may include: generating a number of first heat maps according to the first feature information after the first feature information and the second feature information are input into the third module to obtain the third feature information; generating a number of second heat maps according to the second feature information; generating a number of third heat maps according to the third feature information; combining the first heat maps, the second heat maps and the third heat maps to obtain a number of first combination maps; generating a sample heat map according to each facial key point in the sample image; calculating a third loss value according to the first combination maps and the sample heat maps; and updating the detection model according to the third loss value to obtain the trained detection model.

The method for generating the first heat maps based on the first feature information can be as follows: performing convolution processing on the first feature information to obtain the first heat maps. For example, the convolution processing can use a 3×3 convolution module. For example, the third loss value Loss3 can be calculated using the following equation: Loss3=L1_smooth(FPNₕₑₐₜₘₐₚ, heatmap_gt), where FPN_heatmap represents the first heat maps, the second heat maps or the third heat maps, and heatmap_gt represents the sample heat maps. In one embodiment, the FPN mechanism can be used for combined processing. The present disclosure does not specifically limit the method of combined processing.

In the above-mentioned embodiment, it is equivalent to using the heat map of each keypoint for auxiliary learning, so that the detection module can learn the feature information of each keypoint, thereby improving the detection accuracy of the detection model.

In one embodiment, after obtaining the first combination maps, additional stages can be added for relay supervision. For example, the first combination maps can be processed with convolution to obtain the second combination maps, which serves as a relay supervision stage. In this case, the convolution processing can use a 5×5 convolutional module. Considering both accuracy and efficiency, the value of the number i of the additional stages can be set to 2.

In the method for generating sample heat maps, for example, if there are 98 facial keypoints, a sample heat map is generated for each facial keypoint in the sample image. This means there are a total of 98 facial heat maps.

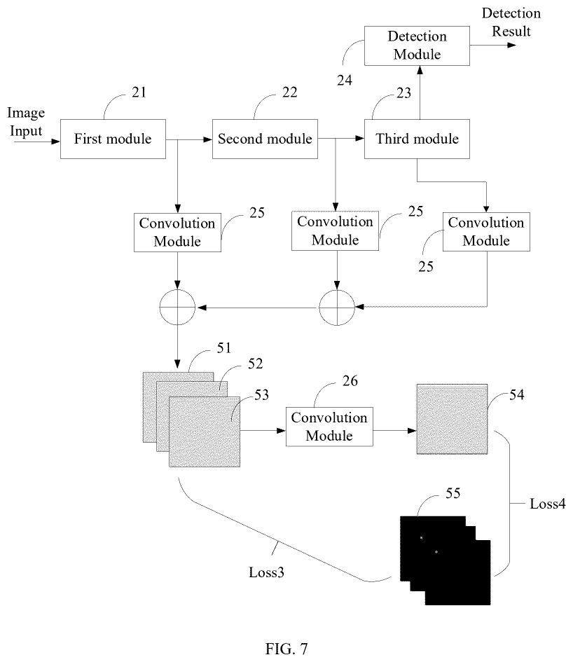

FIG. 7 is a schematic block diagram for executing a training method according to one embodiment. As shown in FIG. 7, a convolution module 25 is added after each of the first module 21, the second module 22 and the third module 23. The convolution module can be used to obtain first heat maps 51 corresponding to the first feature information, second heat maps 52 corresponding to the second feature information and third heat maps 53 corresponding to the third feature information. Then, the convolution module 26 is used to combine the first heat maps, the second heat maps and the third heat maps to obtain first combination maps 54, thereby realizing a stage of relay supervision. Then, the fourth loss value is calculated based on the first combination maps 54 and the sample heat maps 55.

For example, the fourth loss value Loss4, i.e., the loss of relay supervision, can be calculated using the following equation: Loss4=Σᵢ₌₁²L1_smooth(i_th_heatmap, heatmap_gt), where i_th_heatmap represents the combination maps of the i-th stage, and heatmap_gt represents the sample heat maps.

In the above-mentioned embodiment, through relay supervision, it is equivalent to further extracting high-dimensional features based on the combined maps, so that the detection model can learn the characteristics of each dimension of the keypoints, thereby improving the detection accuracy of the model.

It should be noted that the three training methods in FIGS. 5-7 can be executed either individually or in combination. For example, when all three training methods are adopted, the total loss of the detection model is calculated according to the following equation: Loss=ω₀*Loss1+ω₁*Loss2+ω₂*Loss3+ω₃*Loss4, where ω₀, ω₁, ω₂ and ω₃ are weights.

Step S102: Adjust the second keypoints based on a position offset between the first keypoints and the second keypoints, to obtain a number of adjusted second keypoints.

In one embodiment, step S102 may include the following steps: in response to a preset condition being met, performing a weighted sum based on positions of the first keypoints and positions of the second keypoints to obtain a calculation result, wherein the preset condition includes that a number of the second keypoints corresponding to the position offset greater than a preset threshold reaches a preset value; and according to the calculation result, adjusting the positions of the second keypoints to obtain the adjusted second keypoints. If the preset condition is not met, the positions of the second keypoints are replaced by the positions of the first keypoints.

In one embodiment, the position offset can be calculated according to the following equation:

$$Dis ( {P}_{t} , {P}_{t - 1} ) = \sqrt[2]{{( {P}_{t \_ x} - {P}_{t - 1 \_ x} )}^{2} + {( {P}_{t \_ y} - {P}_{t - 1 \_ y} )}^{2}} ,$$

where (P_{t_x}, P_{t_y}) represents a second keypoint, (P_{t-1_x}, P_{t-1_y}) represents a first keypoint, and Dis(Pₜ, Pₜ₋₁) represents position offset.

In the above-mentioned embodiment, the preset condition is equivalent to including two aspects: threshold and quantity. If the position offset is greater than the preset threshold, it means that the position offset of the keypoints is large and the probability of inaccuracy is high; if the quantity reaches the preset value, it means that the number of disturbed keypoints is large, that is, the probability of inaccurate keypoints is high. Based on the two aspects, the jitter of the keypoints can be evaluated more accurately, thereby improving the accuracy of keypoint correction.

Step S103: Detect a blink based on the first keypoints and the adjusted second keypoints.

In one embodiment, step S103 may include the following steps: obtaining a first state of the at least one eye corresponding to the first image; calculating an eye angle according to the second keypoints; detecting a second state of the at least one eye corresponding to the second image according to the eye angle; and performing blink detection according to the first state and the second state.

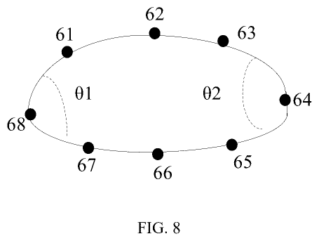

FIG. 8 is a schematic diagram of the keypoints of one eye according to one embodiment. The eye angle can be calculated according to the following equations:

$${θ}_{1} = acos \frac{{d}_{1}^{2} + {d}_{2}^{2} - {d}_{3}^{2}}{2 \times {d}_{1} \times {d}_{2}} ; {θ}_{2} = acos \frac{{d}_{4}^{2} + {d}_{5}^{2} - {d}_{6}^{2}}{2 \times {d}_{4} \times {d}_{5}} ; θ = \frac{{θ}_{1} + {θ}_{2}}{2} ,$$

where d1 represents the distance between keypoints p60 and p62, d2 represents the distance between keypoints p60 and p66, d3 represents the distance between keypoints p62 and p66, d4 represents the distance between keypoints p62 and p64, d5 represents the distance between keypoints p64 and p66, a cos represents the arc cosine function, and θ represents the eye angle. In one embodiment, if θ<20°, it is determined that the eye is in a closing state; otherwise, it is determined that the eye is in an opening state.

In one embodiment, performing blink detection according to the first state and the second state may include the following steps: in response to the first state and the second state representing different eye opening/closing states, determining whether a third state and the second state represent different eye opening/closing states, wherein the third state is an eye opening/closing state corresponding to a third image, and the third image is a previous image frame prior to the first image; and in response to the third state and the second state representing different eye opening/closing states, determining that a blink has occurred.

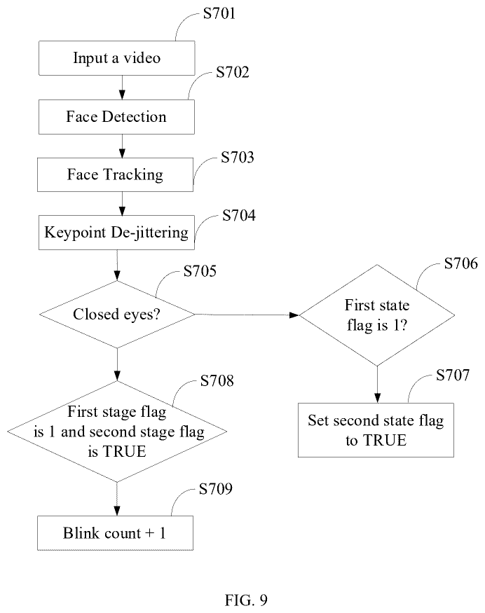

FIG. 9 is an exemplary flowchart of a blink detection method according to one embodiment. As shown in FIG. 9, the blink detection method may include the following steps.

Step S701: Input a video.

Step S702: Perform face detection on each frame of the video.

Step S703: Perform face tracking according to the face detection result.

Step S704: Perform keypoint de-jittering for human eyes for the two consecutive frames based on the face tracking result.

The method for keypoint de-jittering can refer to the description above related to step S102, which will not be repeated here.

Step S705: Determine whether the eyes are in a closed state according to the keypoints of the human eyes after de-jittering.

If the eyes are in a closed state, the procedure goes to step S706 and then to step S707. If the eyes are in an open state, the procedure goes to step S708 and then to step S709.

Step S706: If the eyes are in a closed state, determining whether the current first state flag is 1.

Here, the first state flag indicates the historical state of the eyes, such as the eye opening/closing state corresponding to the previous image frame prior to the current image frame. The first state flag is 1, indicating that the eyes are in an open state, and the first state flag is 0, indicating that the eyes are in a closed state.

It should be noted that after detecting the opening/closing state of the eyes according to each image frame, the first state flag needs to be updated to facilitate determination in the subsequent image frame detection process.

Step S707: In response to the current first state flag being 1, setting the second state flag to “TRUE.”

The second state flag indicates a change in the eye state. When the second state flag is “TRUE,” it is equivalent to a change in the eye state from opening to closing.

Step S708: If the current eyes are in an open state, determine whether the current first state flag is 0 and whether the second state flag is “TRUE.”

Step S709: If the current first state flag is 0 and the second state flag is “TRUE,” which means that the eye state has changed twice from opening eyes to closed eyes and then to opening eyes, determine that a blink has occurred.

Correspondingly, a blink count can be updated. It should be noted that in the embodiment shown in FIG. 9, the process of eye opening to closing, and then back to opening, is considered as one blink. In practical applications, the process of eye closing to opening, and then back to closing, can also be considered as one blink. The detection principle is the same as the process shown in FIG. 9 and will not be repeated here. By using the above blink determination strategy, blink counting can be performed more accurately, thereby helping to improve the reliability of blink detection.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

Corresponding to the blink detection method described in the above embodiment, FIG. 10 is a schematic block diagram of the blink detection device according to one embodiment. For the sake of convenience of explanation, only the part related to the embodiment of the present disclosure is shown.

In one embodiment, the blink detection device may include an acquisition unit 81, an adjusting unit 82 and a detection unit 83. The acquisition unit 81 is to obtain a number of first keypoints of at least one eye in a first image and a number of second keypoints of the at least one eye in a second image, wherein the first image is a previous image frame prior to the second image. The adjusting unit 82 is to adjust the second keypoints based on a position offset between the first keypoints and the second keypoints, to obtain a number of adjusted second keypoints. The detection unit 83 is to detect a blink based on the first keypoints and the adjusted second keypoints.

In one embodiment, the acquisition unit 81 is further to: perform model training on a preset detection model to obtain a trained detection model; and input the first image into the trained detection model and outputting the first keypoints.

In one embodiment, the acquisition unit 81 is further to: obtain a sample image, wherein the sample image includes a face contour connected according to a number of marked facial keypoints; input the sample image into the detection model to obtain the first feature information output by the first module; calculate a feature average value according to the first feature information to obtain a mean feature map; calculate a first loss value according to the mean feature map and the face contour of the sample image; and update the detection model according to the first loss value to obtain a trained detection model.

In one embodiment, the acquisition unit 81 is further to, after inputting the sample image into the detection model to obtain the first feature information output by the first module, input the first feature information into the second module to obtain the second feature information; input the first feature information and the second feature information into the third module to obtain third feature information; input the third feature information into the detection module to obtain a training result; calculate a second loss value based on the training result and the sample image; and update the detection model based on the second loss value to obtain the trained detection model.

In one embodiment, the acquisition unit 81 is further to: generate a number of first heat maps according to the first feature information after inputting the first feature information and the second feature information into the third module to obtain the third feature information; generate a number of second heat maps according to the second feature information; generate a number of third heat maps according to the third feature information; combine the first heat maps, the second heat maps and the third heat maps to obtain a number of first combination maps; generate a sample heat map according to each facial key point in the sample image; calculate a third loss value according to the first combination maps and the sample heat maps; and update the detection model according to the third loss value to obtain the trained detection model.

In one embodiment, the detection unit 83 is further to: in response to a preset condition being met, perform a weighted sum based on positions of the first keypoints and positions of the second keypoints to obtain a calculation result, wherein the preset condition includes that a number of the second keypoints corresponding to the position offset greater than a preset threshold reaches a preset value; and according to the calculation result, adjust the positions of the second keypoints to obtain the adjusted second keypoints.

In one embodiment, the detection unit 83 is further to: obtain a first state of the at least one eye corresponding to the first image; calculate an eye angle according to the second keypoints; detect a second state of the at least one eye corresponding to the second image according to the eye angle; and perform blink detection according to the first state and the second state.

In one embodiment, the detection unit 83 is further to: in response to the first state and the second state representing different eye opening/closing states, determine whether a third state and the second state represent different eye opening/closing states, wherein the third state is an eye opening/closing state corresponding to a third image, and the third image is a previous image frame prior to the first image; and in response to the third state and the second state representing different eye opening/closing states, determine that a blink has occurred.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again.

Each unit in the device discussed above may be a software program module, or may be implemented by different logic circuits integrated in a processor or independent physical components connected to a processor, or may be implemented by multiple distributed processors.

In addition, the device shown in FIG. 10 may be a software unit, a hardware unit, or a combination of software and hardware units built into an existing terminal device, or may be integrated into the terminal device as an independent widget, or may exist as an independent terminal device.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented blink detection method, the method comprising:
obtaining a plurality of first keypoints of at least one eye in a first image and a plurality of second keypoints of the at least one eye in a second image, wherein the first image is a previous image frame prior to the second image;
adjusting the second keypoints based on a position offset between the first keypoints and the second keypoints, to obtain a plurality of adjusted second keypoints; and
detecting a blink based on the first keypoints and the adjusted second keypoints.

2. The method of claim 1, wherein obtaining the plurality of first keypoints of at least one eye in the first image comprises:
performing model training on a preset detection model to obtain a trained detection model; and
inputting the first image into the trained detection model and outputting the plurality of first keypoints.

3. The method of claim 2, wherein the detection model comprises a first module for extracting first feature information according to an input image and a second module for extracting second feature information according to the first feature information, wherein a dimension of the first feature information is greater than a dimension of the second feature information; performing model training on the preset detection model to obtain the trained detection model;
obtaining a sample image, wherein the sample image comprises a face contour connected according to a plurality of marked facial keypoints;
inputting the sample image into the detection model to obtain the first feature information output by the first module;
calculating a feature average value according to the first feature information to obtain a mean feature map;
calculating a first loss value according to the mean feature map and the face contour of the sample image; and
updating the detection model according to the first loss value to obtain a trained detection model.

4. The method of claim 3, wherein the detection model further comprises a third module and a detection module; the method further comprises, after inputting the sample image into the detection model to obtain the first feature information output by the first module,
inputting the first feature information into the second module to obtain the second feature information;
inputting the first feature information and the second feature information into the third module to obtain third feature information;
inputting the third feature information into the detection module to obtain a training result;
calculating a second loss value based on the training result and the sample image; and
updating the detection model based on the second loss value to obtain the trained detection model.

5. The method of claim 4, further comprising, after inputting the first feature information and the second feature information into the third module to obtain the third feature information,
generating a plurality of first heat maps according to the first feature information;
generating a plurality of second heat maps according to the second feature information;
generating a plurality of third heat maps according to the third feature information;
combining the first heat maps, the second heat maps and the third heat maps to obtain a plurality of first combination maps;
generating a sample heat map according to each facial key point in the sample image;
calculating a third loss value according to the first combination maps and the sample heat maps; and
updating the detection model according to the third loss value to obtain the trained detection model.

6. The method of claim 1, wherein adjusting the second keypoints based on the position offset between the first keypoints and the second keypoints, to obtain the plurality of adjusted second keypoints, comprises:
in response to a preset condition being met, performing a weighted sum based on positions of the first keypoints and positions of the second keypoints to obtain a calculation result, wherein the preset condition includes that a number of the second keypoints corresponding to the position offset greater than a preset threshold reaches a preset value; and
according to the calculation result, adjusting the positions of the second keypoints to obtain the adjusted second keypoints.

7. The method of claim 1, wherein detecting the blink based on the first keypoints and the adjusted second keypoints comprises:
obtaining a first state of the at least one eye corresponding to the first image;
calculating an eye angle according to the second keypoints;
detecting a second state of the at least one eye corresponding to the second image according to the eye angle; and
performing blink detection according to the first state and the second state.

8. The method of claim 7, wherein performing blink detection according to the first state and the second state comprises:
in response to the first state and the second state representing different eye opening/closing states, determining whether a third state and the second state represent different eye opening/closing states, wherein the third state is an eye opening/closing state corresponding to a third image, and the third image is a previous image frame prior to the first image; and
in response to the third state and the second state representing different eye opening/closing states, determining that a blink has occurred.

9. A device comprising:
one or more processors; and
a memory coupled to the one or more processors, the memory storing programs that, when executed by the one or more processors, cause performance of operations comprising:
obtaining a plurality of first keypoints of at least one eye in a first image and a plurality of second keypoints of the at least one eye in a second image, wherein the first image is a previous image frame prior to the second image;
adjusting the second keypoints based on a position offset between the first keypoints and the second keypoints, to obtain a plurality of adjusted second keypoints; and
detecting a blink based on the first keypoints and the adjusted second keypoints.

10. The device of claim 9, wherein obtaining the plurality of first keypoints of at least one eye in the first image comprises:
performing model training on a preset detection model to obtain a trained detection model; and
inputting the first image into the trained detection model and outputting the plurality of first keypoints.

11. The device of claim 10, wherein the detection model comprises a first module for extracting first feature information according to an input image and a second module for extracting second feature information according to the first feature information, wherein a dimension of the first feature information is greater than a dimension of the second feature information; performing model training on the preset detection model to obtain the trained detection model;
obtaining a sample image, wherein the sample image comprises a face contour connected according to a plurality of marked facial keypoints;
inputting the sample image into the detection model to obtain the first feature information output by the first module;
calculating a feature average value according to the first feature information to obtain a mean feature map;
calculating a first loss value according to the mean feature map and the face contour of the sample image; and
updating the detection model according to the first loss value to obtain a trained detection model.

12. The device of claim 11, wherein the detection model further comprises a third module and a detection module; the method further comprises, after inputting the sample image into the detection model to obtain the first feature information output by the first module,
inputting the first feature information into the second module to obtain the second feature information;
inputting the first feature information and the second feature information into the third module to obtain third feature information;
inputting the third feature information into the detection module to obtain a training result;
calculating a second loss value based on the training result and the sample image; and
updating the detection model based on the second loss value to obtain the trained detection model.

13. The device of claim 12, wherein the operations further comprise, after inputting the first feature information and the second feature information into the third module to obtain the third feature information,
generating a plurality of first heat maps according to the first feature information;
generating a plurality of second heat maps according to the second feature information;
generating a plurality of third heat maps according to the third feature information;
combining the first heat maps, the second heat maps and the third heat maps to obtain a plurality of first combination maps;
generating a sample heat map according to each facial key point in the sample image;
calculating a third loss value according to the first combination maps and the sample heat maps; and
updating the detection model according to the third loss value to obtain the trained detection model.

14. The device of claim 9, wherein adjusting the second keypoints based on the position offset between the first keypoints and the second keypoints, to obtain the plurality of adjusted second keypoints, comprises:
in response to a preset condition being met, performing a weighted sum based on positions of the first keypoints and positions of the second keypoints to obtain a calculation result, wherein the preset condition includes that a number of the second keypoints corresponding to the position offset greater than a preset threshold reaches a preset value; and
according to the calculation result, adjusting the positions of the second keypoints to obtain the adjusted second keypoints.

15. The device of claim 9, wherein detecting the blink based on the first keypoints and the adjusted second keypoints comprises:
obtaining a first state of the at least one eye corresponding to the first image;
calculating an eye angle according to the second keypoints;
detecting a second state of the at least one eye corresponding to the second image according to the eye angle; and
performing blink detection according to the first state and the second state.

16. The device of claim 15, wherein performing blink detection according to the first state and the second state comprises:
in response to the first state and the second state representing different eye opening/closing states, determining whether a third state and the second state represent different eye opening/closing states, wherein the third state is an eye opening/closing state corresponding to a third image, and the third image is a previous image frame prior to the first image; and
in response to the third state and the second state representing different eye opening/closing states, determining that a blink has occurred.

17. A non-transitory computer-readable storage medium storing instructions that, when executed by at least one processor of a device, cause the at least one processor to perform a method, the method comprising:
obtaining a plurality of first keypoints of at least one eye in a first image and a plurality of second keypoints of the at least one eye in a second image, wherein the first image is a previous image frame prior to the second image;
adjusting the second keypoints based on a position offset between the first keypoints and the second keypoints, to obtain a plurality of adjusted second keypoints; and
detecting a blink based on the first keypoints and the adjusted second keypoints.

18. The non-transitory computer-readable storage medium of claim 17, wherein obtaining the plurality of first keypoints of at least one eye in the first image comprises:
performing model training on a preset detection model to obtain a trained detection model; and
inputting the first image into the trained detection model and outputting the plurality of first keypoints.

19. The non-transitory computer-readable storage medium of claim 18, wherein the detection model comprises a first module for extracting first feature information according to an input image and a second module for extracting second feature information according to the first feature information, wherein a dimension of the first feature information is greater than a dimension of the second feature information;
performing model training on the preset detection model to obtain the trained detection model;
obtaining a sample image, wherein the sample image comprises a face contour connected according to a plurality of marked facial keypoints;
inputting the sample image into the detection model to obtain the first feature information output by the first module;
calculating a feature average value according to the first feature information to obtain a mean feature map;
calculating a first loss value according to the mean feature map and the face contour of the sample image; and
updating the detection model according to the first loss value to obtain a trained detection model.

20. The non-transitory computer-readable storage medium of claim 19, wherein the detection model further comprises a third module and a detection module; the method further comprises, after inputting the sample image into the detection model to obtain the first feature information output by the first module,
inputting the first feature information into the second module to obtain the second feature information;
inputting the first feature information and the second feature information into the third module to obtain third feature information;
inputting the third feature information into the detection module to obtain a training result;
calculating a second loss value based on the training result and the sample image; and
updating the detection model based on the second loss value to obtain the trained detection model.
